(19) United States
(12) Patent Application Publication
(10) Pub. No.: US 2011/0129292 A1
(43) Pub. Date: Jun. 2, 2011

(54) Universal coupling

(76) Inventor: Wan-Bau Chen, Changhua (TW)

(21) Appl. No.: 12/628,231

(22) Filed: Dec. 1, 2009

(51) Int. Cl. F16D 3/20

(52) U.S. Cl. 403/72

(57) ABSTRACT

A universal coupling includes a hollow male sub-assembly comprising an attaching section at one end and a sealing ring seated in the attaching section; and a hollow female sub-assembly comprising a spherical section at the other end. Inserting the spherical section into the attaching section and pressing an edge of the attaching section inward will sealingly urge the sealing ring against the spherical section.

### BACKGROUND OF THE INVENTION

1. Field of Invention

The invention relates to couplings and more particularly to a universal coupling with improved characteristics.

2. Description of Related Art

A conventional quick-release universal coupling is shown in FIGS. 1 to 3 and comprises a hollow male member A including an intermediate annular flange (not numbered), external threads Al extending upward from the flange to one end, and external threads Al extending downward from the flange to the other end; a rubber lower O-ring D rested upon a top shoulder (not numbered) of the male member A; a hollow female member B including an upper cylindrical section B1 and a lower spherical section B2, the female member B (i.e., the lower spherical section B2) being disposed on the lower O-ring D; an interconnecting sleeve C including an axial channel C1 and internal threads C2 on a lower portion; and a rubber upper O-ring D disposed in an annular groove (not numbered) proximate to the top of the interconnecting sleeve C. The interconnecting sleeve C is threadedly secured to the male member A to sealingly urge the upper O-ring D against the spherical section B2. This quick-release universal coupling is substantially leak proof if the threaded coupling is secured.

However, the well known quick-release universal coupling suffers from a couple of disadvantages. For example, the interconnecting sleeve C and the male member A are threadedly secured together. This inevitably can increase the manufacturing cost due to the production of two cooperating parts. Moreover, threaded assembly is a somewhat time consuming process. Thus, a need for improvement exists.

### SUMMARY OF THE INVENTION

It is therefore one object of the invention to provide a universal coupling comprising a hollow male sub-assembly comprising an attaching section at one end and a sealing ring seated in the attaching section; and a hollow female sub-assembly comprising a spherical section at the other end, whereby inserting the spherical section into the attaching section and pressing an edge of the attaching section inward will sealingly urge the sealing ring against the spherical section.

The above and other objects, features and advantages of the invention will become apparent from the following detailed description taken with the accompanying drawings.

### BRIEF DESCRIPTION OF THE DRAWINGS

FIG. 1 is an exploded view of a conventional quick-release universal coupling;

FIG. 2 is a perspective view of the assembled universal coupling shown in FIG. 1;

FIG. 3 is a longitudinal sectional view of the universal coupling shown in FIG. 2;

FIG. 4 is an exploded view of a universal coupling according to the invention;

FIG. 5 is a partially broken away view of the universal coupling shown in FIG. 4;

FIG. 6 is a longitudinal sectional view of the assembled universal coupling shown in FIG. 4;

FIG. 7 is a view similar to FIG. 6 where a top edge of the male sub-assembly is pressed inward to finish the production of the universal coupling of the invention;

FIG. 8 is a perspective view of the universal coupling shown in FIG. 7; and

FIG. 9 is a longitudinal sectional view of the universal coupling shown in FIG. 8 with the female sub-assembly being tilted after swinging a limited angle.

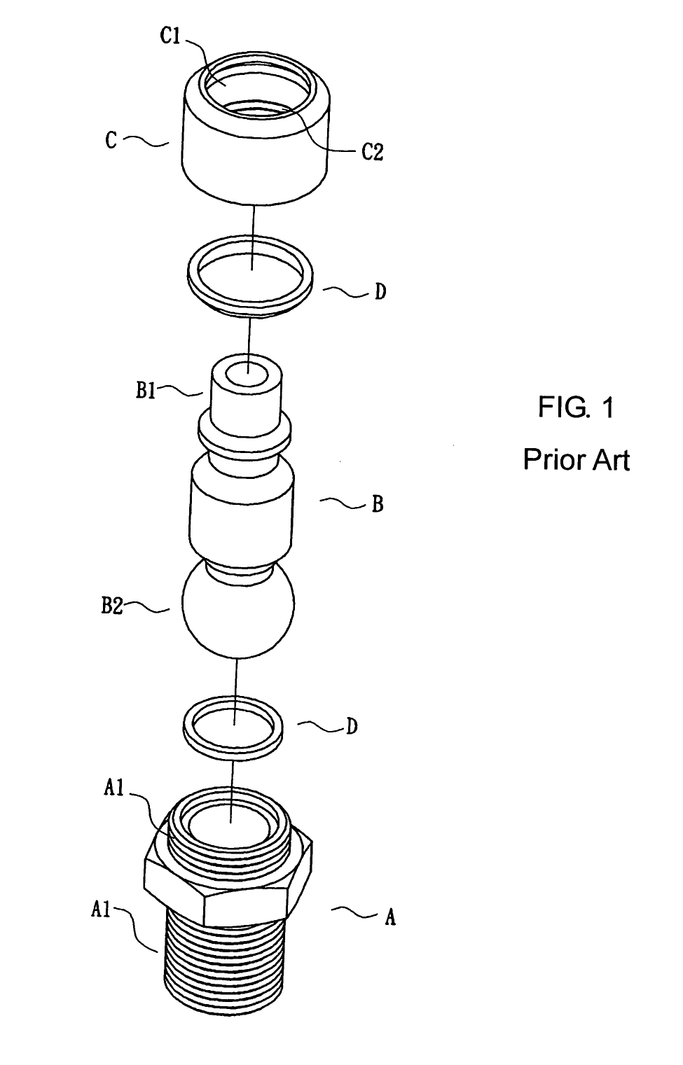

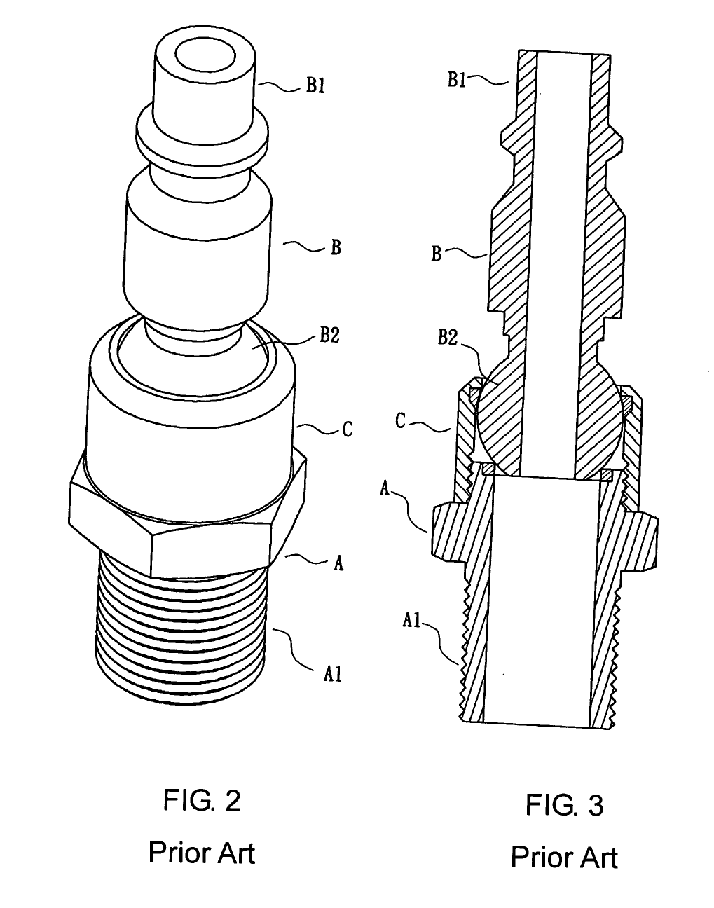

### DETAILED DESCRIPTION OF THE INVENTION

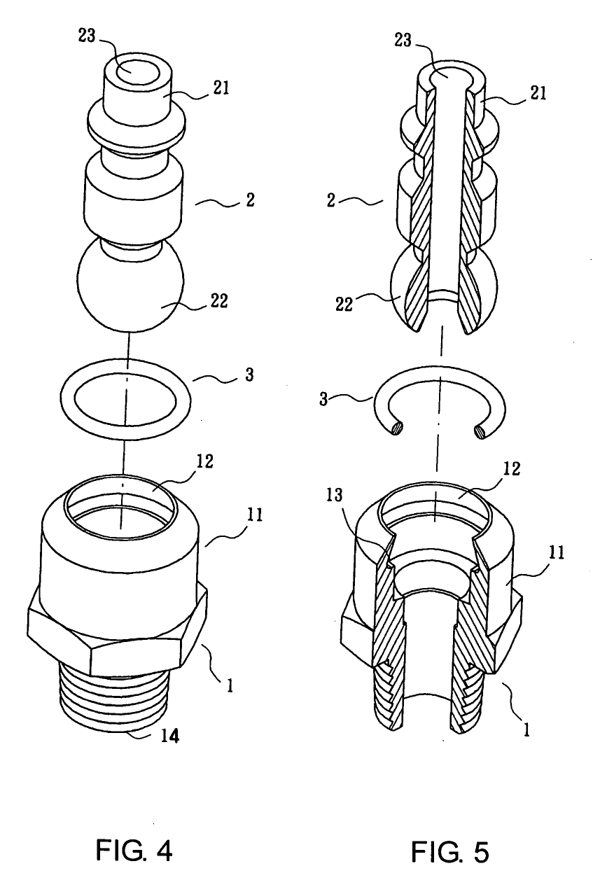

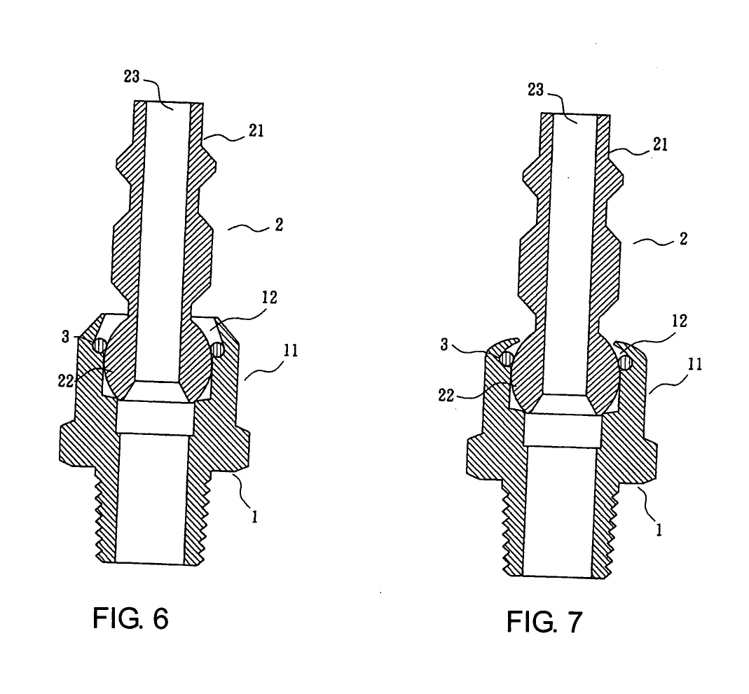

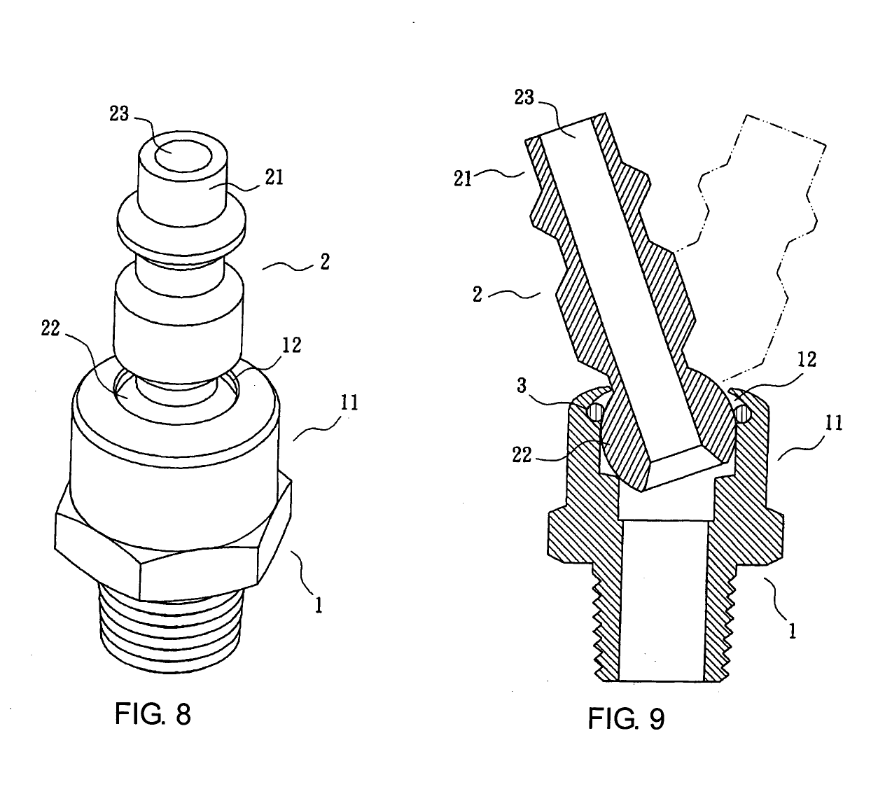

Referring to FIGS. 4 to 9, a universal coupling in accordance with the invention comprises the following components as discussed in detail below.

A hollow male sub-assembly 1 comprises an attaching section 11 at one end, a chamber 12 at the mouth of the attaching section 11, an internal shoulder 13 proximate to the mouth of the attaching section 11, and external threads 14 extending from an intermediate portion to the other end. The external threads 14 are adapted to engage with internal threads of a tube (not shown) to threadedly secure the male sub-assembly 1 and the tube together.

A hollow female sub-assembly 2 comprises an axial channel 23, a cylindrical section 21 extending to one end and being adapted to connect to another tube (not shown), and a spherical section 22 at the other end.

An assembly of the invention will be described in detail below. First, a rubber O-ring 3 is disposed to seat upon the shoulder 13. Next, insert the spherical section 22 into the chamber 12 to dispose therein with the O-ring 13 being engaged with the spherical section 22. Finally, press a top edge of the attaching section 11 inward to sealingly urge the O-ring 3 against the spherical section 22. The assembled universal coupling thus permits the female sub-assembly 2 to swing a limited angle in any direction (see FIG. 9).

The invention has the following advantages. It is leak proof due to the sealing coupling of the O-ring 3 to the spherical section 22 and the sealing coupling of the O-ring 3 to the chamber 12. The number of the components is less. The components are relatively simplified. Further, its assembly is quick and thus saves labor. Furthermore, its manufacturing cost is greatly reduced.

While the invention herein disclosed has been described by means of specific embodiments, numerous modifications and variations could be made thereto by those skilled in the art without departing from the scope and spirit of the invention set forth in the claims.

What is claimed is:

1. A universal coupling comprising:
a hollow male sub-assembly comprising an attaching section at one end and a sealing ring seated in the attaching section; and
a hollow female sub-assembly comprising a spherical section at the other end,
whereby inserting the spherical section into the attaching section and pressing an edge of the attaching section inward will sealingly urge the sealing ring against the spherical section.
